(19) United States
(12) Patent Application Publication
(10) Pub. No.: US 2018/0375203 A1
(43) Pub. Date: Dec. 27, 2018

(54) RADOME WALL WITH MULTILAYER POLYMER SHEET

(71) Applicant: DSM IP ASSETS B.V., Heerlen (NL)

(72) Inventors: Danielle G.I. PETRA, Echt (NL); William A.C. ROOVERS, Echt (NL)

(73) Assignee: DSM IP ASSETS B.V., Heerlen (NL)

(21) Appl. No.: 16/062,438

(22) PCT Filed: Dec. 15, 2016
(86) PCT No.: PCT/EP2016/081293

§ 371 Date: Jun. 14, 2018

(30) Foreign Application Priority Data
Dec. 18, 2015 (EP) 15201136.7

(51) Int. Cl. H01Q 1/42; D03D 15/00; D01F 6/06

(52) U.S. Cl. CPC H01Q 1/424; D01F 6/06; D03D 15/0083; H01Q 1/427

(57) ABSTRACT

The invention relates to a radome wall comprising a multilayer sheet, the multilayer sheet comprising: a) at least one sheet layer A comprising at least two monolayers, the monolayers comprising polymeric fibers, and b) at least one first film layer B1 comprising a polyolefin, wherein the multilayer sheet has a thickness of at least 0.05 mm and at most 0.8 mm. The invention also relates to a radome comprising the radome wall, the radome preferably being a non-ballistic radome, preferably suitable for telecommunications.

The present invention relates to a radome wall comprising a multilayer sheet comprising at least one sheet layer comprising polymeric fibers. The present invention also relates to radome comprising said radome wall and to a system comprising the radome and an antenna.

Radome constructions, or simply radomes, are known in the art as being electromagnetically transparent structures typically used for covering and protecting antennas and for radar systems. By antenna is understood herein a device capable of emitting, radiating, transmitting and/or receiving electromagnetic radiation. By radar is understood herein an object-detection system that uses radio waves to determine the range, angle, or velocity of objects. It is typically used to detect aircraft, ships, spacecraft, guided missiles, motor vehicles, weather formations, and terrain. A radar system usually consists of a transmitter producing electromagnetic waves in the radio or microwaves domain, a transmitting antenna, a receiving antenna (often the same antenna is used for transmitting and receiving) and a receiver and processor to determine properties of the object(s). A microwave antenna typically contains the following main elements: a feed antenna, a reflector dish, a shroud (i.e. a cylindrical housing), the radome (i.e. the front protection cover) and mounting parts (e.g. mount, fixation parts). Examples of typical antennas include air surveillance radar antennas and satellite communication station antennas. Antennas and in particular large antennas such as radar installations, wireless telecom infrastructure and radio telescopes often need a covering structure, such as a radome to protect them from weather conditions, e.g. sunlight, wind and moisture. The presence of a radome is particularly essential for antennas placed in regions where high winds or storms often occur, in order to protect the antennas from hail and impacts from projectiles such as debris carried by the wind. Radome designs usually address structural requirements, including aerodynamic shape, rigidity, and resistance to weather, shock, impact, vibrations and biodegradations, as well as electromagnetic transparency, e.g. a minimal reflection and/or absorption of passing electromagnetic energy, with the purpose of minimizing an electromagnetic energy loss. Structural requirements for radomes are usually met by using composite materials that generally have suitable mechanical properties when constructing a radome and in particular a radome wall. In addition, polyvinylchloride and polypropylene materials are currently being used in making sheets for using in manufacturing radome walls, particularly for radomes used in telecommunications field. Currently, rather complex conical shaped radomes of e.g. made from foamed PVC are used for non-ballistic, telecommunication radomes.

However, the materials that may be applied in the form of sheets for manufacturing the radome walls as known from the prior art have very low or no flexibility and are therefore difficult to transport and can only be used in conical shaped or tilled radome constructions and not in flat radome constructions. In addition, the known sheets show rather low electromagnetic properties, e.g. high dielectric constant and high dielectric loss, especially at high and ultrahigh frequencies. It was also noticed that the sheets made of the composite materials of the prior art have inadequate electromagnetic transparency and in particular a high electromagnetic absorption and/or are highly reflective. Furthermore, some of the known materials used in the radomes construction, such as PVC are environmentally unfriendly and cost ineffective.

The object of the present invention is therefore to provide a sheet that is highly flexible and can be folded, bent and/or rolled during transport without any (visible) damage, e.g. cracks or breaks and can be used in radomes, including in flat shape radomes and additionally that is easier and cheaper to install, fixate and maintain in a radome construction, the sheet being able in the same time to withstand high wind loads requirements and having high transparency for electromagnetic waves over a broad frequency range, high return loss, high scratch resistance, and showing no delamination and no loose filaments during use and being easy to clean and dye.

This object was achieved with a radome wall comprising a multilayer sheet, the multilayer sheet comprising a) at least one sheet layer A comprising at least two monolayers, the monolayers comprising polymeric fibers, and b) at least one first film layer B1 comprising a polyolefin, wherein the multilayer sheet has a thickness of at least 0.05 mm and at most 0.8 mm.

The multilayer sheet used in the radome wall according to the invention is highly flexible and can be folded, bent and/or rolled during transport, without suffering any (visible) damage on its surface and/or in its inner structure, e.g. present as breaks or cracks or voids, this being an important advantage especially for large size and flat shape radome constructions. Furthermore, said sheet is easier and cheaper to install, fixate and maintain as a radome wall and, in the same time, despite its low thickness and the multilayer construction, the radome wall still shows high strength and can withstand high wind loads requirements and have high transparency for electromagnetic waves over a broad frequency range. The radome wall according to the present invention comprising the multilayer sheet also shows high scratch resistance, no delamination and no loose filaments when used in a radome and antenna system and is environmentally friendly and extremely lightweight, which makes it cost effective especially for use in telecommunications radome antennas systems. Also, the fixation of the radome wall comprising said multilayer sheet to the shroud and/or reflector can be applied in a very simple and cost-effective manner.

It is true that document WO2012/080315A1 discloses a material comprising a laminate component containing polymeric fibers wherein the material has an average loss tangent of less than 8×10⁻³ radians measured at frequencies within a frequency interval of between 1 GHz and 130 GHz, the material being made of a number of different layers having different thicknesses and compositions. For instance, the examples of WO2012/080315A1 illustrate multilayer sheets having a total thickness of at least 1 mm and even of 4 mm or higher, the sheets being in a form of a panel. However, this document does not disclose a specific multilayer sheet having a total thickness of at least 0.05 mm and at most 0.8 mm, and comprising monolayers of polymeric fibers and at least one polyolefinic film nor suggests that such a specific multilayer sheet is a.o. highly flexible and can be folded, bent and/or rolled during transport, without suffering any (visible) damage and being easier to install, fixate and maintain as a radome wall and, in the same time, despite its low thickness and the multilayer construction, the radome wall still showing high strength and being able to withstand high wind loads requirements, and having high transparency for electromagnetic waves over a broad frequency range.

By “fiber” is herein understood an elongated body having a length, width and a thickness, with the length dimension of said body being greater than the transverse dimensions of width and thickness. The fibers may have continuous lengths, known in the art as filaments, or discontinuous lengths, known in the art as staple fibers. The fibers may have various cross-sections, e.g. regular or irregular cross-sections with a circular, bean-shape, oval or rectangular shape and they can be twisted or non-twisted. Preferably, the fibers of the present invention are tapes.

By “yarn” is herein understood an elongated body containing a plurality of fibers or filaments, i.e. at least two individual fibers or filaments. By individual fiber or filament is herein understood the fiber or filament as such. The term “yarn” includes continuous filament yarns or filament yarns which contain a plurality of continuous filament fibers and staple yarns or spun yarns containing short fibers also called staple fibers. Such yarns are known to the skilled person in the art.

By “sheet” is herein understood a flat body having a length, a width and/or a diameter much greater than thickness, as also typically known to the skilled person in the art. By “multilayer sheet” is herein understood a sheet comprising more than one layer in its structure. By a “flexible sheet” is herein understood a multilayer sheet that may be folded, rolled, put on a roll or bended without any (visible) damage. A measure of the flexibility of said multilayer sheet may be when a sample of said multilayer sheet having a supported end, i.e. the end thereof which is placed on a rigid support such as a table; a free end, i.e. the unsupported end; and a length of 500 mm between the rigid support and the free end, will deflect under its own weight with an angle of preferably less than 86.5°, yet preferably less than 80°, still yet preferably, less than 70°, more preferably less than 60°, yet more preferably less than 50°, still more preferably less than 40°, most preferably less than 30°, yet most preferably less than 10° and still most preferably less than 5° between said sheet and the horizontal axis. The lower the angle value, the more flexible multilayer sheet.

By “tape” is herein understood a body having a length dimension, a width dimension and a thickness dimension, wherein the length dimension of the tape is at least about the same as its width dimension but preferably greater than its width dimension, and wherein said length dimension is much greater than its thickness dimension. Preferably, the term “tape” also comprises the embodiments of a ribbon, a strip, a film and may have a continuous or a discontinuous length with a regular or an irregular cross-section. Particularly, a tape has a cross sectional aspect ratio, i.e. the ratio of width to thickness, of preferably at least 5:1, more preferably at least 20:1, even more preferably at least 100:1 and yet even more preferably at least 1000:1, and most preferably at least 2500:1 and yet most preferably at least 5000:1. The width of the tape is preferably at least 1 mm and at most 600 mm (but only limited by practicalities) and more preferably between 10 mm and 400 mm, even more preferably between 30 mm and 300 mm, yet even more preferably between 50 mm and 200 mm and most preferably between 70 mm and 150 mm.

The term “film” is generally known to the person skilled in the art as typically being a thin and flexible layer of a material.

In the context of the present invention, “high strength polyethylene fibers” include fibers comprising ultrahigh molecular weight polyethylene (UHMWPE) polymer. In the context of the present invention “high strength” fiber term is interchangeable with “high performance” fiber or with “high modulus” fiber term.

The thickness of each layer in the multilayer sheet and of the multilayer sheet is herein understood the average thickness of each of said layers. The average thickness can be measured by any method known in the art, e.g. with a microscope on different cross-sections of the tape and then averaging the results. The average thickness and thus the thickness of each layer and of the multilayer sheet according to the present invention was measured according to the method as described in the “Examples” section of this patent application.

Preferably, the multilayer sheet in the radome wall according to the invention has a deflection angle of preferably less than 86.5°, yet preferably less than 80°, still yet preferably, less than 70°, more preferably less than 60°, yet more preferably less than 50°, still more preferably less than 40°, most preferably less than 30°, yet most preferably less than 10° and still most preferably less than 5° between said sheet and the horizontal axis. The deflection angle indicating the flexibility of the sheet may be calculated as indicated in the “Examples” section herein below. The lower the angle value, the higher flexibility of the multilayer sheet.

The multilayer sheet in the radome wall according to the present invention has a thickness of at least 0.05 mm and at most 0.8 mm, being highly flexible and having high strength, and being easier to handle and fold, bent and/or rolled for transport, without any (visible) damage on its surface or in its structure, which is particularly relevant for flat shape and large size radome constructions. Moreover, said sheet is easier fixed to the shroud and/or reflector; capable to withstand wind loads of at least 250 km/h to even 450 km/h; and in the same time is highly transparent for electromagnetic waves over a broad frequency range, e.g. from 1 GHz to 130 GHz, preferably between 1 GHz to 100 GHZ. By the thickness of the multilayer sheet is herein meant the total thickness of the multilayer sheet, which is the sum of the thickness of all layers e.g. monolayers and film(s) present in the construction of the multilayer sheet according to the present invention.

Preferably, the thickness of the multilayer sheet is in a range of between at least 0.06 mm and at most 0.8 mm, more preferably between at least 0.08 mm and at most 0.7 mm and most preferably at least 0.1 mm and at most 0.6 mm and yet most preferably between at least 0.2 mm and at most 0.4 mm. Preferably, the thickness of said multilayer sheet is at least 0.05 mm, more preferably at least 0.08 mm, even more preferably at least 0.1 mm and most preferably at least 0.15 mm and yet most preferably at least 0.2 mm. Radome walls comprising thinner multilayer sheets are not able to withstand the required wind loads and/or other mechanical requirements. The thickness of the multilayer sheet is at most 0.8 mm, preferably at most 0.7 mm, more preferably at most 0.6 mm, even more preferably at most 0.55 mm, yet more preferably at most 0.5 mm, even more preferably at most 0.45 mm, and most preferably at most 0.4 mm and yet most preferably at most 0.3 mm. Radome walls with thicker multilayer sheets (e.g. in the form of panels) show less RF transparency, more electromagnetic signal reflection and very low or no flexibility during use being more difficult to install on a frame.

The multilayer sheet comprises at least one sheet layer A comprising at least two monolayers, the monolayers comprising polymeric fibers, preferably polymeric tapes. Preferably, the sheet layer A comprises an even number of monolayers in a range of between 2 and 14 monolayers, yet preferably at most 12 monolayers, more preferably at most 8 monolayers, still more preferably at most 6 monolayers and most preferably at most 4 monolayers. A higher number of monolayers in sheet layer A results in less RF transparency, more electromagnetic reflection and less or no flexibility of the radome wall of the invention, with the results of being (visibly) damaged when rolled, bent or folded during transport.

The term “polymeric tape” means herein a tape comprising a polymer. Said polymer may be any polymer and/or polymer composition, preferably any polymer and/or polymer composition that can be manufactured into fibers. Preferably, the sheet layer A comprises at least two monolayers, said monolayers comprising high performance polymer fibers. In the context of the present invention, “high performance fibers” include fibers comprising a polymer selected from a group comprising or consisting of homopolymers and/or copolymers of alpha-olefins, e.g. ethylene and/or propylene; polyoxymethylene; poly(vinylidine fluoride); poly(methylpentene); poly(ethylene-chlorotrifluoroethylene); polyamides and polyaramides, e.g. poly(p-phenylene terephthalamide) (known as Kevlar®); polyarylates; poly(tetrafluoroethylene) (PTFE); poly{2,6-diimidazo-[4,5b-4′,5′e]pyridinylene-1,4(2,5-dihydroxy)phenylene} (known as M5); poly(p-phenylene-2,6-benzobisoxazole) (PBO) (known as Zylon®); poly(hexamethyleneadipamide) (known as nylon 6,6); polybutene; polyesters, e.g. poly(ethylene terephthalate), poly(butylene terephthalate), and poly(1,4 cyclohexylidene dimethylene terephthalate); polyacrylonitriles; polyvinyl alcohols and thermotropic liquid crystal polymers (LCP) as known from e.g. U.S. Pat. No. 4,384,016, e.g. Vectran® (copolymers of para hydroxybenzoic acid and para hydroxynaphtalic acid). Also combinations of such polymers can be used for manufacturing the sheet layer A. Preferably, the polymeric fibers in sheet A comprise a polyolefin, preferably an alpha-polyolefin, such as propylene homopolymer and/or ethylene homopolymers and/or copolymers comprising propylene and/or ethylene. The average molecular weight (M_{w}) and/or the intrinsic viscosity (IV) of said polymeric materials can be easily selected by the skilled person in order to obtain a fiber having desired mechanical properties, e.g. tensile strength. The technical literature provides further guidance not only to which values for M_{w} or IV a skilled person should use in order to obtain strong fibers, i.e. fibers with a high tensile strength, but also to how to produce such fibers.

Alternatively, high performance fibers may be understood herein to include polymeric fibers or yarns having a tenacity or tensile strength of at least 12 cN/dtex, more preferably at least 25 cN/dtex, most preferably at least 35 cN/dtex, yet most preferably at least 40 cN/dtex. There is no reason for an upper limit of the tenacity of the inventive yarn, whereby UHMWPE yarns having tenacities of up to about 60 cN/dtex may be currently manufactured. Generally such high-strength yarns also have a high tensile modulus, e.g. a tensile modulus of at least 500 cN/dtex, preferably at least 750 cN/dtex, more preferably 1000 cN/dtex and most preferably at least 1250 cN/dtex. Tensile strength, also simply referred to as strength, tenacity and modulus of fibers can be determined by known methods, as those based on ASTM D885M.

More preferably, said polyolefin in sheet layer A is a polyethylene homopolymer, even more preferably a high performance polyethylene, and most preferably high molecular weight polyethylene (HMWPE) or ultrahigh molecular weight polyethylene (UHMWPE). By UHMWPE is herein understood a polyethylene having an intrinsic viscosity (IV) of at least 4 dl/g, more preferably at least 8 dl/g, most preferably at least 12 dl/g. Preferably said IV is at most 50 dl/g, more preferably at most 35 dl/g, more preferably at most 25 dl/g. Intrinsic viscosity is a measure for molecular weight (also called molar mass) that can more easily be determined than actual molecular weight parameters like Mn and M. The IV may be determined according to ASTM D1601(2004) at 135° C. in decalin, the dissolution time being 16 hours, with BHT (Butylated Hydroxy Toluene) as anti-oxidant in an amount of 2 g/I solution, by extrapolating the viscosity as measured at different concentrations to zero concentration. Preferably, the IV is between 4 and 40 dL/g, more preferably between 6 and 30 dL/g and most preferably between 8 and 25 dL/g to provide fibers, yarns and objects with optimal mechanical properties. When the intrinsic viscosity is too low, the strength necessary for using various molded articles from the UHMWPE sometimes cannot be obtained, and when it is too high, the processability, etc. upon molding is sometimes worsen.

By UHMWPE fibers or yarns are herein understood to be fibers or yarns comprising ultra-high molar mass polyethylene and having a tenacity of at least 25 cN/dtex, preferably at least 28 cN/dtex, more preferably at least 32 cN/dtex and most preferably at least 35 cN/dtex. There is no reason for an upper limit of tenacity of UHMWPE fibres or yarns in a sheet, but available fibres or yarns typically are of tenacity at most about 50 to 60 cN/dtex. The UHMWPE fibres or yarns also have a high tensile modulus, e.g. of at least 75 cN/dtex, preferably at least 100 or at least 125 cN/dtex.

The UHMWPE fibers or yarns have preferably a titer of at least 5 dtex, more preferably at least 10 dtex. For practical reasons, the titer of the fibers are at most several thousand dtex, preferably at most 5000 dtex, more preferably at most 3000 dtex. Preferably the titer of the fibers is in the range of 10 to 10000, more preferably 15 to 6000 and most preferably in the range from 20 to 3000 dtex.

The UHMWPE fibres have preferably a filament titer of at least 0.1 dtex, more preferably at least 0.5 dtex, most preferably at least 0.8 dtex. The maximum filament titer is preferably at most 50 dtex, more preferably at most 30 dtex and most preferably at most 20 dtex.

The polymeric fibres in layer A may be obtained by various processes, for example by a melt spinning process, a gel spinning process or a solid state powder compaction process. The high strength polyethylene fibers may be manufactured according to a gel spinning process. Preferably, the high strength polyethylene fibers comprise gel-spun fibers, i.e. fibers manufactured with a gel-spinning process. Suitable examples of gel spinning processes are described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1 and EP 1,699,954. According to the invention, a gel-spinning process is used to manufacture the inventive UHMWPE fibers, wherein the UHMWPE polymer is used to produce an UHMWPE solution, which is subsequently spun through a spinneret and the obtained gel fiber is dried to form a solid fiber. In particular, the gel spinning process typically comprises preparing a solution of UHMWPE polymer and a solvent, extruding the solution into fibers at a temperature above the dissolving temperature of UHMWPE, cooling down the fibers below their gelling temperature, thereby at least partly gelling the fibers, and drawing the fibers before, during and/or after at least partial removal of the solvent. Drawing of the fibers typically comprise at least one drawing step wherein the spun filaments are drawn in at least one stage preferably with a draw ratio of at least 4. Preferably, drawing is performed in at least two stages, and preferably at different temperatures with an increasing profile. The drawing preferably takes place between about 120 and about 155° C. The gel-spun fibers obtained may contain very low amount of residual solvent, for instance at most 500 ppm.

The sheet layer A has preferably a thickness of at least 0.02 mm, more preferably at least 0.03 mm, yet more preferably at least 0.04 mm. The sheet layer A has preferably an average thickness of at most 0.3 mm, more preferably at most 0.2 mm, even more preferably at most 0.1 mm.

The polymeric tapes may be a fibrous material or a non-fibrous material, preferably a fibrous material that is that the tape comprises fibres. The polymeric tapes may be prepared by any method already known in the prior art. The non-fibrous tape can be obtained with a process different than a process comprising a step of producing fibers and a step of using, e.g. fusing, the fibers to make a tape. For instance, the non-fibrous tape may be obtained by feeding a polymeric powder between a combination of endless belts, compression-moulding the polymeric powder at a temperature below the melting point, also referred to as the melting temperature, thereof and rolling the resultant compression-moulded polymer followed by drawing. Such a process is for instance described in EP 0 733 460 A2, incorporated herein by reference. Compression moulding may also be carried out by temporarily retaining the polymer powder between the endless belts while conveying them. This may for instance be done by providing pressing platens and/or rollers in connection with the endless belts. Preferably, when UHMWPE is the polymer used in such process, then UHMWPE needs to be drawable in the solid state. The non-fibrous tape obtained is also known as “solid state tape”.

Another process for the formation of polymeric tapes may be by melt-spinning and comprises feeding a polymer to an extruder, extruding a tape at a temperature above the melting point thereof and drawing the extruded polymeric tape below its melting temperature to obtain a melt-spun polymeric tape. The melt-spun polymeric tape is typically substantially free of any solvent.

The polymeric tapes may also be prepared by a gel spinning process, e.g. the tapes comprise gel spun UHMWPE. A suitable gel spinning process is described in for example GB-A-2042414, GB-A-2051667, EP 0205960 A and WO 01/73173 A1, and in “Advanced Fibre Spinning Technology”, Ed. T. Nakajima, Woodhead Publ. Ltd (1994), ISBN 185573 182 7. In short, the gel spinning process comprises preparing a solution of a polymer of high intrinsic viscosity, extruding the solution into a tape at a temperature above the dissolving temperature of the polymer, cooling down the film below the gelling temperature, thereby at least partly gelling the tape, and drawing the tape before, during and/or after at least partial removal of the solvent. The product obtained typically contain some solvent at ppm level, for instance at most 500 ppm.

In the described methods to prepare the polymeric tapes, the drawing, preferably uniaxial drawing, of the produced tapes may be carried out by means known in the art. Such means comprise extrusion stretching and tensile stretching on suitable drawing units. To attain increased mechanical strength and stiffness, drawing may be carried out in multiple steps. In case of tapes comprising a polyolefin, preferably a polyethylene and more preferably UHMWPE, drawing is typically carried out uniaxially in a number of drawing steps. The first drawing step may for instance comprise drawing to a stretch factor of 3. In case that the polyolefin is UHMWPE, a multiple drawing process is preferably used where the tapes are stretched with a factor of 9 for drawing temperatures up to 120° C., a stretch factor of 25 for drawing temperatures up to 140° C., and a stretch factor of 50 for drawing temperatures up to and above 150° C. By multiple drawing at increasing temperatures, stretch factors of about 50 and more may be reached.

The polymeric tapes may have a tensile strength of at least 0.3 GPa, more preferably at least 0.5 GPa, even more preferably at least 1 GPa, most preferably at least 1.5 GPa as measured according to the methods in the Example section herein below.

Preferably, the polymeric tapes in sheet layer A form a fabric, preferably a woven fabric. By fabric of polymeric tapes is herein understood a fabric wherein the tapes are unidirectionally aligned and run along a common direction with their lengths defining and being contained by a single plane. A gap may exist between two adjacent tapes, said gap being preferably at most 10%, more preferably at most 5%, most preferably at most 1% of the width of the narrowest of said two adjacent tapes. Preferably, the tapes are in an abutting relationship. More preferably, the fabric comprises adjacent tapes that overlap each other along their length over part of their surface, preferably the overlapping part being at most 50%, more preferably at most 25%, most preferably at most 10% of the width of the narrowest of said two overlapping adjacent tapes. Preferably, the running common direction of the tapes in a layer is under an angle with the running common direction of the tapes in an adjacent layers, said angle being preferably between 45° and 90°, more preferably about 90°. Very good results are obtained when the polymeric tapes form a woven fabric. Preferred woven structures are plain weaves, basket weaves, satin weaves and crow-foot weaves. Most preferred woven structure is a plain weave. Preferably, the thickness of a woven fabric is between 1.5 times and 3 times the thickness of a tape, more preferably about 2 times the thickness of a tape.

The monolayers in the sheet layer A may be weaved by processes already known in the art. Weaving of tapes is known per se, for instance from document WO2006/075961, which discloses a method for producing a woven layer from tape-like warps and wefts comprising the steps of feeding tape-like warps to aid shed formation and fabric take-up; inserting tape-like weft in the shed formed by said warps; depositing the inserted tape-like weft at the fabric-fell; and taking-up the produced woven monolayer; wherein said step of inserting the tape-like weft involves gripping a weft tape in an essentially flat condition by means of clamping, and pulling it through the shed. The inserted weft tape is preferably cut off from its supply source at a predetermined position before being deposited at the fabric-fell position. When weaving tapes specially designed weaving elements are used. Particularly suitable weaving elements are described in U.S. Pat. No. 6,450,208. Preferably, the woven structure of said monolayers is a plain weave. Preferably, the weft direction in a monolayer in the sheet layer A is under an angle with the weft direction in an adjacent monolayer. Preferably said angle is 90°.

The monolayers in the sheet layer A may contain an array of unidirectionally arranged polymeric tapes, i.e. tapes running along a common direction. Preferably, the tapes partially overlap along their length. The common direction of the tapes in a monolayer may be under an angle with the common direction of the tapes in an adjacent monolayer, e.g. said angle is about 90°. The tapes may be subjected to pressure, preferably at a temperature below the melting temperature (Tm) of the polyolefin as determined by DSC, to form a consolidated sheet of layer A. When the tapes are arranged into monolayers, preferably the consolidated sheet is obtained by pressing a plurality of the monolayers at increased pressures, preferably at a temperature below Tm. Useful pressures may be pressures of at least 1 bar, preferably at least 10 bar, yet preferably at least 15 bar, more preferably at least 20 bar, yet more preferably at least 40 bar and most preferably at least 50 bar. Lower pressures decrease adhesions between monolayers of layer A. Preferably, said pressure is at most 100, more preferably at most 165 bar, most preferably at most 200 bar, yet most preferably at most 300 bar. The temperature used is preferably of between 120° C. below Tm and Tm, more preferably between 50° C. below Tm and 2° C. below Tm. Suitable temperatures when UHMWPE tapes are used include between 30° C. and 160° C., more preferably between 50° C. and 150° C.

Preferably, the sheet layer A comprises or consists of at least one woven layer, preferably between 1 and 7 woven layers, more preferably between 1 and 3 woven layers, each woven layer consisting of two monolayers that are woven together and combined in an woven fabric, said monolayers comprising or consisting of polymeric fibers, preferably polymeric tapes. One monolayer in sheet layer A may also be interchangeably referred to herein as one “ply”. Still preferably, every two adjacent monolayers of sheet layer A, preferably two tape adjacent monolayers, are woven into one plain woven structure. More preferably, each plain woven structure contain two cross-plied tape monolayers that may be cross-plied in an angle of 0.90°.

The multilayer sheet comprises b) at least one film layer B1, the film layer comprising a polyolefin. The thickness of the film layer B1 is preferably in a range between 0.004 mm and 0.5 mm, more preferably between 0.005 and 0.4 mm and most preferably between 0.006 mm and 0.08 mm and even most preferably between 0.005 mm and 0.04 mm. Preferably, the thickness of the film layer B1 is at least 0.005 mm, more preferably at least 0.006 mm, yet more preferably at least 0.007 mm, yet more preferably at least 0.01 mm, most preferably at least 0.02 mm, yet most preferably at least 0.04 mm and even most preferably at least 0.06 mm. A thinner film layer B1 deteriorates its adhesion to the sheet layer A. Preferably, the thickness of the film layer B1 is at most 0.3 mm, more preferably at most 0.2 mm, yet more preferably at most 0.1 mm, yet more preferably at most 0.09 mm or even at most 0.08 mm. A thicker film layer B1 deteriorates the electromagnetic properties and RF transparency reflection of the radome wall comprising the multilayer sheet according to the present invention.

The film layer B1 preferably comprises any polyolefin known in the art and/or mixtures thereof, such as a polypropylene or a polyethylene, more preferably a polyethylene, yet more preferably low density polyethylene (LDPE), linear low density polyethylene (LLDPE), very low density polyethylene (VLDPE) and most preferably LDPE, and/or a mixture of these polyethylenes as the mechanical properties of the radome wall comprising the multilayer sheet improve, i.e. the amount of cracks and/or delamination between the layers in said multilayer sheet decreases and the adhesion between the layers increases. In addition, the film layer B1 preferably comprising a polyethylene and more preferably LDPE prevents loose filaments being formed on the surface of the sheet layer A during the use of the multilayer sheet. The polyolefins in film layer B1 may be manufactured by any method already known in the art. Also the film layer B1 improves the smoothness, abrasion resistance, scratch resistance of the surface of the multilayer sheet according to the invention and the aesthetics of the radome wall.

The multilayer sheet according to the present invention preferably comprises a number of film layers B1 in a range between of at least 1 and at most 8 film layers B1, yet preferably in a range between of at least 1 and at most 5 film layers B1, more preferably between at least 1 and at most 3 film layers B1. Higher number of film layers B1 decreases the RF transparency and flexibility of the radome wall comprising the multilayer sheet according to the present invention, and in the same time the production of such a thicker multilayer sheet is more complex and costly.

Preferably, the multilayer sheet further comprises at least one film layer B2, the film layer B2 comprising a polymer, which may be any polymer known in the art and that may be produced by any method already known in the art. The film layer B2 may be also referred herein to as a “finishing film layer” as it is a layer that may be located on at least one of the upper surface and/or of the lower surface of the sheet layer A in the multilayer sheet of the radome wall according to the present invention.

The polymer in said film layer B2 is preferably a thermoplastic (co)polymer or an elastomer as known in the art. The polymer in said film layer B2 is more preferably selected from a group comprising or consisting of a polyolefin and/or a polar polymer, preferably a polyolefin or a polar polymer. More preferably, the polyolefin is a polyethylene, preferably high low density polyethylene (HDPE) or a polypropylene, e.g. a polypropylene homopolymer or propylene-based copolymer and/or a mixture thereof. Most preferably, said film layer B2 comprises a polymer selected from a group comprising polypropylenes; polyethylenes, e.g. high density polyethylene (HDPE); polyurethanes, e.g. aliphatic or aromatic polyurethanes comprising ether or ester groups; polyacrylates, e.g. PMMA; epoxy resins; polyacetates, e.g. ethyl-vinyl acetate; polyesters, e.g. polyethylene terephthalate (PET), polybutylene terephthalate (PBT), polycarbonates; polyamides, e.g. polyamide-6, polyamide-6,6; acrylonitrile butadiene styrene (ABS); polystyrenes, polyamines, and/or a mixture thereof.

Preferably, the film layer B1 comprises a different polymer than the polymer in the film layer B2. Preferably, the film layer B1 comprises LDPE and the film layer B2 comprises HDPE.

The multilayer sheet preferably comprises a number of film layers B2 in a range between of at least 1 and at most 8 film layers B1, yet preferably in a range between at least 1 and at most 5 film layers B2, more preferably between 1 and 3 film layers B2. By increasing the number of film layers B2, the RF transparency and flexibility of the radome wall according to the present invention comprising the multilayer sheet decrease, and in the same time, the production of a thicker layer B2 is difficult and costly, as well such a multilayer sheet being more difficult to install in a frame.

The thickness of the film layer B2 is preferably between 0.005 mm and 0.5 mm, more preferably between 0.006 and 0.4 mm and most preferably between 0.004 and 0.08 mm and even most preferably between 0.005 and 0.04 mm. Preferably, the thickness of the film layer B2 is at least 0.005 mm, more preferably at least 0.006, yet more preferably at least 0.007 mm, yet more preferably at least 0.01 mm, most preferably at least 0.02 mm, yet most preferably at most 0.04 mm and even most preferably at least 0.06 mm. A thinner film layer B2 may deteriorate its adhesion to the layer A. Preferably, the thickness of the film layer B2 is at most 0.3 mm, more preferably at most 0.2 mm, yet more preferably at most 0.1 mm, yet more preferably at most 0.09 mm or even at most 0.08 mm. A thicker film layer B2 may deteriorate the electromagnetic properties and RF transparency reflection of the radome wall according to the present invention comprising the multilayer sheet.

Each of the layers B1 and B2 may also further comprise any additives known in the art, in any conventional amounts, such as various fillers, pigments and additives, e.g. flame-retardants, stabilizers, e.g. ultraviolet (UV) stabilizers, colorants, pigments, e.g. white pigment, dyes. The amount of the various fillers, pigments and additives may be between 0 and 30 wt %, more preferably between 0.05 and 20 wt %.

Preferably, the multilayer sheet comprises or consists of at least one sheet layer A and at least one film layer B1 and optionally at least one film layer B2. More preferably, the multilayer sheet comprises or consists of one sheet layer A, one or two film layer B1 and optionally one film layer B2.

The multilayer sheet comprises at least one sheet layer A and at least one film layer B1 and optionally at least one film layer B2, said layers preferably forming a stack, said stack having an upper-stack surface and a lower-stack surface opposite to the upper-stack surface, wherein at least said upper-stack surface, more preferably both said upper- and lower-stack surfaces comprise at least one film layer B1 and optionally at least one film layer B2. It goes without saying that although called upper-stack surface and lower-stack surface, these denominations are not limiting and they are interchangeable.

Each layer of the multilayer sheet typically has an upper surface (herein may also be referred to as “upper side”) and a lower surface (herein may also be referred to as “lower side”) opposite to the upper surface. It goes without saying that although called upper surface and lower surface, these denominations are not limiting and they are interchangeable.

Preferably, the sheet layer A comprises an upper surface and a lower surface opposite to the upper surface, wherein at least said upper surface, more preferably both said upper and lower surfaces comprise the film layer B1 and optionally the film layer B2. Preferably, the film layer B1 also comprises an upper surface and a lower surface opposite to the upper surface, wherein said lower surface optionally comprises the layer B2 and the upper surface comprise the sheet layer A in the multilayer sheet. When both said upper and lower surfaces of a sheet layer A comprises each one layer B1, then the layer B1 has an upper surface comprising the sheet layer A and a lower surface optionally comprising the layer B2, and the lower surface of layer B2 is free. When layer B2 is present, than layer B2 is the outmost lower and the outmost upper layer in the multilayer sheet (i.e. it faces towards outside the multilayer sheet; there is nothing else located between film layer B2 and outside of the sheet). When layer B2 is not present, than layer B1 is the outmost upper and the outmost lower layer in the multilayer sheet.

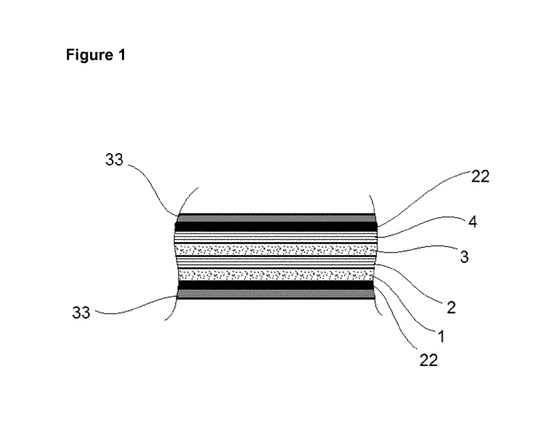

FIG. 1 schematically illustrates a preferred multilayer sheet construction for manufacturing the radome wall according to the present invention, wherein 1, 2, 3 and 4 each represents one monolayer or ply comprising polymeric fibers and form together sheet layer A, wherein monolayer 1 is cross-plied with monolayer 2 (i.e. in an angle of 0.90°) to form a 2-ply plain woven structure and monolayer 3 is cross-plied with monolayer 4 (in an angle of 0.90°) to form another 2-ply plain woven structure, the two plain woven structures being stacked on top of each other and forming sheet layer A; 22 is layer B1 and 33 is layer B2.

The film layers B1 and B2 may each be applied in the multilayer sheet by any method known in the art. For example, said layers may be individually applied as a liquid coating, e.g. spray coating that is typically afterwards dried and forms a film. Such liquid coating is known in the art and typically include a film surface treatment (e.g. by corona treatment, plasma treatment, flame treatment, applying an adhesion promoter) or by activating the film surface by using a primer solution. However, although liquid coating provides the film with a homogeneous colour, it is known to be an expensive process. Said films may also alternatively be applied as a freestanding coating film that is for example laminated on one or both sides of a monolayer in the sheet according to the invention. Preferably, each of said films is applied as a freestanding coating film by any process known in the art, preferably at pressures of at least 1 bar, preferably at least 10 bar, yet preferably at least 15 bar, more preferably at least 20 bar, yet more preferably at least 40 bar and most preferably at least 50 bar. Lower pressures decrease adhesions between monolayers. Preferably, said pressure is at most 100 bar, more preferably at most 165 bar, most preferably at most 200 bar, yet most preferably at most 300 bar. The temperature at which the film monolayers are applied in the sheet according to the invention is preferably of between 120° C. below Tm and Tm, more preferably between 50° C. below Tm and 2° C. below Tm. Suitable temperatures include between 30° C. and 160° C., more preferably between 50° C. and 150° C.

It is not essential for the present invention that the thickness of the individual layers in the sheet is substantially the same at every location thereon. It is preferred that the thickness of each of said layers is substantially constant at least at the location or locations where the electromagnetic signal interacts with said monolayers. However, for ease of manufacturing it is preferred that the thickness of the monolayers when measured at various locations of said monolayers is about the same.

Preferably, the multilayer sheet in the radome wall according to the invention is free of any matrix, binder, impregnated component or any other component that is usually used in the art to bind the tapes or monolayers forming said sheet together. It was observed that a sheet free of matrix and/or binder shows improved electrical properties.

The multilayer sheet can be attached in any way known in the art to a profile and form the radome wall according to the present invention. For instance, such a fixation method is described in detail in WO2014140260. The multilayer sheet may be fixated by clamping it to a plastic or metal profile with clamping means that may contain a bolt and a nut system. The clamping means can be made of a rigid material that may be a metal selected from the group comprising of steel, aluminium, bronze, brass, and the like. The sheet can be mounted and tensioned between the frames of the profile, for example, by pulling on the edge of the sheet material, then locking the clamping means, and/or by using a seal and/or by gluing the sheet to the frame by using any glue known in the art suitable for it and/or by stitching a piping, such as a braided rope or a cable around the sheet circumference and, if desired cutting then the excess sheet material. It is also possible to attach the sheet material at the premises of the manufacturer prior to field use. After tensioning and locking, the excess multilayer sheet material may then be removed.

The present invention further relates to a process for producing the radome wall according to the present invention comprising the multilayer sheet, the processcomprising a step of stacking a) at least one sheet layer A; b) at least one film layer B1 and optionally c) at least one film layer B2 to form a multilayer sheet having a thickness of at least 0.05 mm and at most 0.8 mm.

Preferably, the process for producing the radome wall comprising the multilayer sheet as comprises the steps of:
a) providing at least one stack comprising at least one sheet layer A;
b) placing at least one film layer B1 and optionally at least one film layer B2 on the upper surface and/or the lower surface of the at least one stack obtained in step a) to obtain an assembly containing at least one sheet layer A, at least one layer B1 and optionally said at least one layer B2;
c) pressing the assembly obtained in step b) and obtain a multilayer sheet comprising at least one sheet layer A, said layer A comprising at least two monolayers, the monolayers comprising polymeric fibers, and at least one first film layer B1, said layer B1 comprising a polyolefin having a thickness of at least 0.05 mm and at most 0.8 mm.

The at least one stack comprising at least one sheet layer A preferably has an upper surface and a lower surface, which is opposite to the upper surface.

Preferably, the lateral dimensions of width and length of the film layer B1 and optionally of the film layer B2 are chosen to at least match the lateral dimensions of the stack, such that said layer(s) cover the upper-stack surface substantially in its entirety.

At least one pre-formed polymeric film may be also employed on the upper and/or lower surface of said layers B1 and/or B2. Pre-formed polymeric films manufactured from various polymeric materials can be used according to the process of the invention. Preferably, said pre-formed polymeric film is manufactured from a polymeric material that is different, e.g. it belongs to a different polymeric class, than the polymeric material used to manufacture the layers in the sheet as this may ease the removal of the pre-formed polymeric film. Preferred polymeric materials for manufacturing the pre-formed polymeric films used in accordance to the process of the invention include polyvinyl-based materials, e.g. polyvinyl chloride, and silicone-based materials. Good results may be obtained when the pre-formed polymeric films are films manufactured from polyvinyl chloride or silicon rubber. The pre-formed polymeric film is preferably used for high-pressure press known in the art as batch production of the product is not economically feasible if using other presses. By pre-formed polymeric film is herein understood a film manufactured from a polymeric material, wherein said film is freestanding, e.g. a sample of said film of e.g. 50 cm×50 cm does not break under its own weight when suspended at a height of double its highest dimension.

The thickness of at most 0.8 mm of the multilayer sheet does not take into account the pre-formed polymeric film as said film is typically removed after pressing. The thickness of the pre-formed polymeric film is preferably at least 50 μm, more preferably at least 100 μm, most preferably at least 150 μm. Preferably, the thickness of the pre-formed polymeric film is between 100 μm and 25 mm, more preferably between 200 μm and 20 mm, most preferably between 300 μm and 15 mm. For example, for silicon rubber films most preferred thicknesses are between 500 μm and 15 mm, while for polyvinyl chloride films most preferred thickness are between 1 mm and 10 mm. Silicon rubber and polyvinyl chloride films having a wide range of thicknesses are commercially available and may be obtained e.g from Arlon (US) and WIN Plastic Extrusion (US), respectively.

Good results may be obtained when the pre-formed polymeric film has a tensile strength of between 3 MPa and 25 MPa or more. In case a polyvinyl chloride film is used as the pre-formed polymeric film, said polyvinyl chloride film preferably has a tensile strength of between 10 MPa and 25 MPa. In case a silicon rubber film is used as the pre-formed polymeric film, said silicon rubber film preferably has a tensile strength of between 3 MPa and 20 MPa. Preferably, the pre-formed polymeric film has an elongation at break of between 100 and 600% or more. In case a polyvinyl chloride film is used as the pre-formed polymeric film, said polyvinyl chloride film preferably has an elongation at break of between 100% and 500%. In case a silicon rubber film is used as the pre-formed polymeric film, said silicon rubber film preferably has an elongation at break of between 300% and 900. Good results may be obtained when the pre-formed polymeric film has a tensile modulus is between 3 MPa and 100 MPa. In case a polyvinyl chloride film is used as the pre-formed polymeric film, said polyvinyl chloride film preferably has a tensile modulus of between 3 MPa and 25 MPa. In case a silicon rubber film is used as the pre-formed polymeric film, said silicon rubber film preferably has a tensile modulus of between 1 MPa and 20 MPa. Pre-formed polymeric films manufactured from the above mentioned materials and having the above mentioned properties are commercially available. Moreover, the skilled person can easily produce such films with techniques commonly known in the art, e.g. extrusion, extrusion-moulding, solid-state compression or film-blowing, and stretch these films unidirectionally or bidirectionally to such an extent to obtain the required mechanical properties.

Preferably, the layers A, B1 and optionally B2 used in the process of the invention are the layers of the embodiments detailed in the paragraphs hereinabove and used in accordance with the invention. Preferably, polyolefin tapes, more preferably polyethylene tapes, most preferably UHMWPE tapes are used in sheet layer A.

Preferably the stacking of the of the at least two sheet layers A is carried out such that said layers overlap over a major part of their surface, e.g. over more than 80%, preferably more than 90%, most preferably more than 95% of their surface, preferably such that the layers overlap substantially over their entire surface.

The assembly of step b) of the process of the invention may be pressed at step c) with a pressure of at least 1 bar, preferably at least 10 bar, yet preferably at least 15 bar, more preferably at least 20 bar, yet more preferably at least 40 bar and most preferably at least 50 bar. Lower pressures decrease adhesions between monolayers. Preferably, said pressure is at most 300 bar, more preferably at most 200 bar, most preferably at most 165 bar, yet most preferably at most 100 bar. Any conventional pressing means may be utilized in the process of the invention e.g. a WN Anlagepress. It was observed that good results may be obtained if a double belt press is used. Double belt presses are known in the art and are manufactured for example by Hymmen (DE).

The temperature during the step c) is preferably chosen below the melting temperature (Tₘ) of the polymeric fibers in layer A as measured by DSC. In case the assembly contains more than one type of polymeric fibers in the tapes of layer A, by melting temperature is herein understood the lowest melting temperature of the more than one type of polymeric fibers. Preferably, said temperature is between 120° C. and Tm, more preferably between 50° C. below Tm and 2° C. below Tm. Preferably the temperature during the compression step c) is at most 20° C., more preferably at most 10° C. and most preferably at most 5° C. below the melting temperature of the polymeric fibers. For example, in the case of polyethylene fibers and more in particular in case of UHMWPE fibers, a temperature for compression of preferably between 135° C. and 150° C., more preferably between 140° C. and 150° C. may be chosen. The minimum temperature generally is chosen such that a reasonable speed of consolidation is obtained. In this respect 50° C. is a suitable lower temperature limit, preferably this lower limit is at least 75° C., more preferably at least 95° C., most preferably at least 115 C.

After pressing the assembly in step c), the assembly may be cooled under pressure, after which the pressure may be released. The pre-formed polymeric film may be removed from the assembly and a multilayer sheet having a thickness of at most 0.8 mm is obtained. Said sheet shows at least one of the following advantages: it has higher flexibility, e.g. it can be folded and/or rolled during transport; it is suitable for applying a dye; it is particularly suitable in the construction of telecom radomes as it also has high transparency for electromagnetic waves over a broad frequency range and shows better mechanical properties, e.g. higher scratch resistance, no delamination of the layers, no loose filaments while having high tensile strength, withstands high wind loads requirements, and has high RF transmission efficiency.

The invention also relates to a radome wall comprising the multilayer sheet obtainable with the process of the invention as described herein, said multilayer sheet comprising a) at least one sheet layer A comprising at least one monolayer, each monolayer comprising polymeric fibers and b) at least one film layer B1 comprising a polyolefin and optionally, c) at least one film layer B2 comprising a polymer, and wherein the multilayer sheet has a thickness of at least 0.05 mm and at most 0.8 mm. The radome wall obtainable by the process shows many advantages compared to the sheets or flat/conical shaped panels known in the prior art used for radomes, especially for non-ballistic or telecommunication radomes i.e. it has higher flexibility (e.g. it can be bent, folded or rolled up during transport without any (visible) damage); it can be dyed and painted; it has high transparency for electromagnetic waves over a broad frequency range and shows better mechanical properties (e.g. having high tensile strength and withstanding high wind loads requirements) and at the same time shows a high scratch resistance, no delamination of the layers, no loose filaments and high RF transmission efficiency during use.

Therefore, the radome wall according to the present invention is particularly suitable for use in radomes and particularly in the construction of non-ballistic radomes, particularly in radomes suitable for telecommunication (known as telecom radomes) and in telecommunication systems that comprise antennas, radar systems and radomes, in mobile masts and communication base stations. Due to its very low thickness, the multilayer sheet according to the present invention is not be suitable for ballistic applications.

Preferably, the radome wall comprises the multilayer sheet comprising at least one sheet layer A comprising an upper surface and a lower surface opposite to the upper surface, wherein at least said upper surface, more preferably both said upper and lower surfaces comprise the film layer B1 and at least said upper surface optionally comprises the film layer B2. Also preferably, the film layer B1 also comprises an upper surface and a lower surface opposite to the upper surface, wherein said lower surface optionally comprises the layer B2 and the upper surface comprise the layer A in the multilayer sheet. More preferably, the multilayer sheet in said article comprises one sheet layer A comprising an upper surface and a lower surface opposite to the upper surface, wherein both said upper surface and lower surface comprise the film layer B1 and said upper surface comprises the film layer B2. Most preferably, the multilayer sheet in said article comprises one sheet layer A, that comprises an upper surface and a lower surface opposite to the upper surface, wherein both said upper surface and lower surface comprise the film layer B1 and said upper surface comprises the film layer B2, wherein film layer B2 is free (i.e. B2 is the last layer in the sheet and it faces towards outside the sheet; there is nothing else located between film layer B2 and the outside of the sheet) and layer B1 directly faces the outside, e.g. faces the reflector and the antenna in a radome. When layer B2 is present, than layer B2 is the outmost lower layer and the outmost upper layer in the multilayer sheet. When layer B2 is not present, than layer B1 is the outmost upper layer and outmost lower layer in the multilayer sheet.

The invention also directs to a radome comprising a radome wall according to the present invention, the radome wall comprising the multilayer sheet as described herein comprising:
a) at least one sheet layer A comprising at least two monolayers, the monolayers comprising polymeric fibers, and
b) at least one first film layer B1 comprising a polyolefin, wherein the multilayer sheet has a thickness of at least 0.05 mm and at most 0.8 mm.

Furthermore, the present invention also relates to a system comprising a radome comprising the radome wall according to the invention and an antenna and/or a radar.

Furthermore, the present invention relates to the use of the radome wall according to the present invention in the construction of radomes, preferably in the construction of radomes suitable for telecommunications, more preferably in the construction of non-ballistic radomes.

It is noted that the invention relates to all possible combinations of features recited in the claims. Features described in the description may further be combined.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

The invention will be further elucidated with the following examples without being limited hereto.

### EXAMPLES

### Methods of Measuring

Flexural strength and modulus of the sheet according to the present invention were measured according to ASTM D790-07. To adapt for various thicknesses of the film layers, measurements were performed according to paragraph 7.3 of ASTM D790-07 by adopting a loading and a support nose radius, which are twice the thickness of the laminate component and a span-to-depth ratio of 32.
Tensile properties of fibers, e.g. tensile strength and tensile modulus, were determined on multifilament yarns as specified in ASTM D885M, using a nominal gauge length of the fibre of 500 mm, a crosshead speed of 50%/min and Instron 2714 clamps, of type Fibre Grip D5618C. For calculation of the strength, the tensile forces measured are divided by the titre, as determined by weighing 10 metres of fibre; values in GPa for are calculated assuming the natural density of the polymer, e.g. for UHMWPE is 0.97 g/cm3.
Tensile properties of tapes, e.g. tensile strength and tensile modulus were defined and determined as specified in ASTM D882 at 25° C., on tapes (if applicable obtained from films by slitting the films with a knife) of a width of 2 mm, using a nominal gauge length of the tape of 440 mm and a crosshead speed of 50 mm/min. If the tapes were obtained from slitting films, the properties of the tapes were considered to be the same as the properties of the films from which the tapes were obtained.
Tensile modulus of film layers was measured according to ASTM D-638(84) at 25° C. and about 50% relative humidity.
Tensile strength of film layers was measured according to ASTM D882-10 at 23° C. and about 50% relative humidity.
Flexibility was measured on a sample of said sheet having a supported end, i.e. the end thereof which was placed on a rigid table; a free end, i.e. the unsupported end; and a length of 500 mm between the rigid support and the free end, will deflect under its own weight with an angle of more than 10 between the sheet and the horizontal axis. A sheet having a total length of about 65 cm was used. A length of 15 cm of the sheet (the first part of the sheet) was positioned on the surface of the table and then pressed against the table with a clamp. The remaining 50 cm in length of the sheet (the second part of the sheet) was positioned between the table and the free end. The angle “alpha” formed by these two parts of the sheet (deflection angle) was then measured three independent times by applying the same method and calculated with the relation: alpha=cos⁻¹ (P2−P1)/L, wherein P1 is the distance (cm) between the floor plane (on which the table stands) and the end of the second part of the sheet (i.e. the end of the 50 cm long sheet, at the side of the floor); P2 is the height of the table from the floor plane to the top of the table (P2=97.4 cm) and L is the length of the second part of the sheet (L=50 cm). The average number of these 3 independent measurements performed on the same sample (for P1 and thickness of the multilayer sheet) is reported in Table 1.
Thickness of any one of the layers in the sheet and of the sheet according to the invention was measured with a micrometer on an original location and on eight peripheral locations, said peripheral locations being within a radius of at most 0.5 cm from the original location, and averaging the values. Melting temperature (Tₘ), and heat of fusion (ΔH_{F}) were established by differential scanning calorimetry (DSC) according to ISO-11357-3 by evaluation of the second heating curve at a heating rate of 10° C./min in the interval from room temperature to 200° C. The crystallinity (Xₑ) was calculated from the equation: X_{c}=ΔH_{F}/ΔH_{F}⁰, where ΔH_{F}⁰ is the heat of fusion of perfect crystalline HDPE which is assumed to be equal to 280 J/cm³.
Intrinsic Viscosity (IV) for UHMWPE was determined according to ASTM D1601/2004 at 135° C. in decalin, while shaking the mixture for 16 hours, with BHT (Butylated Hydroxy Toluene) as anti-oxidant in an amount of 2 g/I solution. IV is obtained by extrapolating the viscosity as measured at different concentrations to zero concentration.
dtex: fibers' titer (dtex) was measured by weighing 100 meters of fiber. The dtex of the fiber was calculated by dividing the weight in milligrams by 10.
Electromagnetic properties, e.g. dielectric constant and dielectric loss, were determined for frequencies of between 1 GHz and 10 GHz with the well-known Split Post Dielectric Resonator (SPDR) technique. For frequencies of above 10 GHz, e.g. of between 10 GHz and 144 GHz, the Open Resonator (OR) technique was used to determine said electromagnetic properties, wherein a classical Fabry-Perot resonator setup having a concave mirror and a plane mirror was utilized. More details on the method of measurement of dielectrics and loss tangent at 100 GHz using a network analyzer can be found in T. M. Hirvonen and P. Vainikainen et al. in IEEE Transactions on instrumentation and measurement, vol. 45, no. 4, August 1996, page 780-786 and on dielectric measurements at 35 Ghz using an open microwave resonator can be found in R. G. Jones, in Proc. IEE, vol. 123, No. 4, April 1976, page 285-290. For both techniques plain samples were used, i.e. samples not having any curvature in the plane defined by their width and length. Since in the case of the SPDR technique, for each frequency at which the dielectric properties are measured a separate setup has to be utilized, the SPDR technique was carried out at the frequencies of 3.9 and 5 GHz. The setups corresponding to these frequencies are commercially available and were acquired from QWED (Poland). The software delivered with these setups was used to compute the electromagnetic properties. For the OR technique, the setup was built in accordance with the instructions given in Chapter 7.1.17 of “A Guide to characterization of dielectric materials at RF and Microwave frequencies” by Clarke, R N, Gregory, A P, Cannell, D, Patrick, M, Wylie, S, Youngs, I, Hill, G, Institute of Measurement and Control/National Physical Laboratory, 2003, ISBN: 0904457389, and all the references cited in that chapter, i.e. references 1-6, and in particular reference [3] R N Clarke and C B Rosenberg, “Fabry-Perot and Open-resonators at Microwave and Millimetre-Wave Frequencies, 2-300 GHz”, J. Phys. E: Sci. Instrum., 15, pp 9-24, 1982. The OR technique was carried out at the frequencies of 35, 50 and 72 GHz. The relative permittivity (also known as dielectric constant) is computed form the change in the length of the resonator required to maintain the same resonance mode on inserting the sample. The loss tangent value is computed from the corresponding change in Q-factor. The coefficient of variation of the dielectric constant and the loss tangent in a frequency interval were calculated by measuring 3 values of the dielectric constant and loss tangent in the frequency interval, computing from these values the average dielectric constant and loss tangent and the standard deviation of the dielectric constant and loss tangent, and dividing said standard deviation to said average.
Return loss (RL) measurements were done according to the standard method IEEE Std. 149-1979, Chapter 15, in front of a microwave dish antenna for different frequency bands, as specified herein below: at room temperature, by using an anechoic chamber and carrying out calibration at antenna transmission line port, by using of a parabolic dish and placing the radome perpendicular on the beam.
Wind load test was performed in the following way:

A conical shaped sample holder clamping device having a 13 cm diameter was used in a tensile tester to analyze the maximum force that can be applied on a radome made with the multilayer sheet according to the present invention. A conical shaped sample holder was used in order to be able to generate more clamping force on the sheet to reduce the chance of slipping. A round stamp with a diameter of 11 cm was used to apply the maximum force on the radomes containing the sheet of the invention. The maximum force is defined as the force at the moment when there is no slipping of the multilayer sheet according to the invention in the conical holder and the sheet is not damaged.

A wind load was simulated by applying sand bags on the radome. A wind speed of 250 km/h was simulated by applying 450 kg of sand bags on a surface of a 4 ft radome (1.2 m) in diameter multilayer sheet according to the invention and then applying a pressure of 3982 N/m² (0.0039 MPa) on the radome. The force applied by wind on the flat radome surface was calculated according to the well-known Drag equation: F=Cd*½*p*V²*A, wherein Cd=the Drag coefficient and is 1.17 for a flat surface; V²=wind speed (m/s)=250 km/h=69.4 m/s; A=radome surface (m²)=4 ft diameter=(4*0.3 m)²*π/4=1.13 m²; δ air=1.293 kg/m³. Thus, F=1.17*½*1.293*(69.4)²*1.13=4117 N. Thus, a very high force of 4117 N can be applied on the radome, without damaging or braking the surface of the radome.

When applying 51 N with a stamp on the 13 cm diameter sheet, the same average wind load force of 250 km/h was applied/simulated as with the 450 kg sand bags on a 1.2 m diameter sheet radome.

The wind load force was simulated by pressing the stamp on the multilayer sheet with a speed of 10 and 100 mm/min and started at 10 N to evaluate the maximum obtainable wind load force on the multilayer sheet in the conical shaped sample holder. It was observed that a 2500 N force can be applied on the 13 cm diameter on the sheet clamped in the conical shaped sample holder (0.25 MPa) without slip in the conical shaped sample holder and the sheet stays intact, i.e. does not damage or break. The fixation in the conical shaped holder of the high strength multilayer sheet was very good in order to be able to obtain these high forces.

A constant force test with 500 N for 60 min was performed to analyze constant high wind loads on the multilayer sheet used in a radome in the same way as the maximum wind load test as described herein above. The measurement started at 10 N force. An additional displacement in the tensile tester occurred of only 0.5 mm in order to maintain the force of 500 N for 60 min on the multilayer sheet.

Production of a Solid State Tape Comprising UHMWPE

A powder bed of UHMWPE powder was compacted in a double belt press at a pressure of 40 bar and a temperature of 130° C. The aerial density of the powder bed was 1 kg per square meter. The resulting product was compressed between two calendar rolls at a temperature of 135° C., down to a thickness of 270 microns and subsequently was drawn with a factor 10 in an oven at 147° C. and then it was drawn again in another oven with a factor 2.5 at a temperature of 150° C. The resulting oriented tape had a thickness of 42 microns, a tensile strength of 1.7 GPa, a tensile modulus of 115 GPa and a width of 35 cm. The ratio of tensile strength of the tape in longitudinal direction to tensile strength of the tape in transversal direction was 150.

Production of Woven Sheets Comprising UHMWPE

4 monolayers of the tape as obtained as described under Production of a solid state tape comprising UHMWPE, each monolayer containing a 10 cm width and 0.042 mm thick solid-state UHMWPE tape produced as described herein above, were woven into two plain woven structures, each plain woven structure containing two 0.90° cross-plied monolayers consisting of said tapes. The two plain weave structures were stacked on top of each other under ambient condition (room temperature of about 23° C.) to produce one fabric sheet layer having 4 monolayers, each monolayer consisting of said tape. The obtained sheet was cut in a sheet sample having a width of 40 cm, a length of 40 cm and a thickness of 0.17 mm, a tenacity of 8.5 cN/dTex in the 0.90° direction of the tape and an area density of 168 g/m².

Production of a Radome Wall

Press pads of a silicone rubber with a hardness of 60 shore A (commercially available from Hofland Deltaflex) were applied during the press process on one side (i.e. on the upper surface) of the sheet, for the homogenous distribution of the pressure. One two-layered finishing film was then applied on both sides of the sheet sample according to Examples and Comparative Examples herein and then the assembly so formed was pressed in a one step process in a hydraulic press at a temperature of 145° C., under a pressure of 50 bars and a dwell time of 10 min. Afterwards, the assembly was cooled to room temperature (about 23° C.), the silicone rubber pads were removed and a multilayer sheet was thus obtained.

The multilayer sheet obtained by Production of woven sheets comprising UHMWPE and according to Examples 1 and Comparative Examples herein was then mounted on a plastic ring frame by clamping it to the frame by using bold and nut system to form a radome wall.

### Example 1

A two-layer film with a thickness of 0.04 mm was applied on the lower and the upper sides of the multilayer sheet obtained as described above in Production of woven sheets comprising UHMWPE. The film comprises one 0.02 mm thick layer film comprising LDPE commercially available from SABIC® under the name HP2023N and LLDPE commercially available from SABIC® under the name 6135NE, 0.8 wt % UV-stabilizer commercially available as UVS225 made by A. Schulman Company, 0.2 wt % Chimassorb 944 commercially available from BASF and 0.4 wt % TiO₂ commercially available from BASF and one 0.02 mm thick layer film containing HDPE commercially available from SABIC® under the trade name F10750, 0.2 wt % Chimassorb 944 UV stabilizer, commercially available from BASF and 0.4 wt % TiO₂ commercially available from BASF The sheet sample was facing the LDPE/LLDPE film layer at the lower side and the HDPE film layer at the upper side. The multilayer sheet obtained had a thickness of 0.21 mm. The tenacity of the sample was 8.5 cN/dTex.

### Example 2

Example 1 was repeated with the only difference that the film layer containing HDPE had a thickness of 0.04 mm. The thickness of the multilayer sheet was 0.29 mm and the areal density was 288 g/m².

### Example 3a

Example 1 was repeated with the only difference that one multilayer sheet was produced with a film having an areal density of 65 g/m² and made of one 0.05 mm thick LDPE film and one 0.015 mm thick polyamide-6 film commercially available from DSM under the trade name Akulon™ F130. The multilayer sheet had a thickness of 0.29 mm and an areal density of 298 g/m². The results on flexibility measurements of this sample are shown in Table 1.

### Example 3b

Example 3a was repeated with the only difference that the layer sheet A had 8 monolayers formed in 4 plain woven structures, each woven structure containing two 0.90° cross-plied tape monolayers, the woven structures being stacked on top of each other. The results on flexibility measurements of this sample are shown in Table 1.

### Example 3c

Example 3a was repeated with the only difference that the layer sheet A had 12 monolayers formed in 6 plain woven structures, each woven structure containing two 0.90° cross-plied tape monolayers, the woven structures being stacked on top of each other. The results on flexibility measurements of this sample are shown in Table 1.

### Comparative Example 3a

Example 3a was repeated with the only difference that the layer sheet A had 16 monolayers formed in 8 plain woven structures, each woven structure containing two 0.90° cross-plied tape monolayers, the woven structures being stacked on top of each other. The results on flexibility measurements of this sample are shown in Table 1.

### Comparative Example 3b

Example 3a was repeated with the only difference that the layer sheet A had 24 monolayers formed in 12 plain woven structures, each woven structure containing two 0.90° cross-plied tape monolayers, the woven structures being stacked on top of each other. The results on flexibility measurements of this sample are shown in Table 1.

### Example 4

Example 1 was repeated with the only difference that the film had an areal density of 20 g/m² and was consisting of one 0.020 mm thick LDPE film located on both sides of sheet layer A. The multilayer sheet had a thickness of 0.21 mm and an areal density of 208 g/m².

### Example 5

Example 1 was repeated with the only difference that the finishing film having an areal density of 60 g/m² and was consisting of one 0.045 mm thick LDPE film and one 0.015 mm thick PET film commercially available from SABIC® under the name BC111. The multilayer sheet had a thickness of 0.29 mm and an areal density of 288 g/m².

It was observed that the radome wall obtained with Examples 1-5 remained intact (e.g. the sheet was not damaged or broken) when high forces were applied. It was specifically observed that when a 4500 N force was applied on a 11 cm diameter radome in the wind load test as described herein above, the radome wall was not damaged or broke, resulting thus a radome with high safety factor. Furthermore, due to its high flexibility, the multilayer sheet of Examples 1-5 could be easier rolled, bent and folded and transported without any damages (e.g. brakes or cracks), whereas the multilayer sheet obtained according to Comparative Examples 3 was rigid, panel-type sheet also when used for large size radomes. In addition, the multilayer sheet was a simple flat product form, suitable also for construction of flat shape radomes and also for large size radomes. These flat product form allowed a more simple and more cost-efficient attachment method to a radome frame or reflector or alike. The multilayer sheet had high strength, was environmentally friendly and translucent for light, this property being relevant for a good quality control of the radome construction. Moreover, the radome wall obtained according to Examples 1-5 had high scratch resistance and showed no delamination and no loose filaments during use compared with the radome wall obtained by Comparative Examples 3 that showed low scratch resistance and showed high delamination and loose filaments during use.

Table 1 shows that the multilayer sheets according to the present invention (Examples 3 a-c) had much higher flexibility compared with the multilayer sheets having a thickness of higher than 0.8 mm (Comparative Examples 3a-b). It was also observed that the multilayer sheets according to the present invention did not show any (visual or in their internal structure) damage nor delamination upon rolling, bending and folding it, whereas the multilayer sheets obtained according to the Comparative Examples 3a-b showed that visual and internal damages (present as voids or cracks) and delamination of the sheet occurred upon rolling, bending and folding said sheet.

Furthermore, RF return loss measurements were performed at frequencies between 7.1 and 40 GHz on: i) a sheet as produced in Example 1, with the difference that 2 monolayers of tape were used instead of 4 monolayers of tape; the thickness of the sheet was 0.09 mm; ii) a sheet as produced in Example 1; iii) a 0.5 mm thick sheet consisting of 3 layers of sheets as produced in Example 1, each layer of sheet having 4 monolayers of tape; the 3 layers of sheets were consolidated using the above described pressing procedure under Production of woven sheets comprising UHMWPE. It was observed that at increasing thickness of the sheet, the RL of the electromagnetic radiation is increasing. The 0.09 and 0.17 mm thick sheet is obtaining a RL of 19 dB and 18 dB, respectively. The 0.5 mm thick sheet obtained a RL of 15 dB. Furthermore, multilayer sheets with thicknesses of higher than 0.8 mm (panels shape) were not flexible enough to be able to fold, bent or roll without damaging it (visible cracks and delamination occurred in the sheet while bending, folding or rolling) and showed lower transparency for electromagnetic waves.

RF return loss measurements were also performed between 7.1 and 40 GHz on the multilayer sheet of Example 3. Suitable return loss values were obtained by applying different frequency bands: 7.1 to 8.5 GHz=19 dB; 10 to 11.7 GHz=17 dB; 12.7 to 13.25 GHz=22 dB; 14.2 to 15.35 GHz=21 dB; 17.7 to 19.7 GHz=18 dB; 21.2 to 23.6 GHz=19 dB; 24.25 to 26.5 GHz=19 dB; 27.5 to 29.5 GHz=17 dB; 31 to 33.4 GHz=17 dB; 37 to 40 GHz=17 dB. It can be seen that the radome wall according to the present invention can be used over a broad frequency range, the low RF values obtained showing that the radome wall according to the invention results in little or no detuning of the antenna and that the transmission efficiency of the radome wall is very high.

TABLE 1

| | | | | Thickness |
|---|---|---|---|---|
| | Number of | | | multilayer |
| | monolayers | P1 | Angle | sheet |
| Sample | in sheet A | [cm] | [°] | [mm] |
| Ex. 3a | 4 | 64.1 | 48.24 | 0.29 |
| Ex. 3b | 8 | 88.7 | 79.98 | 0.47 |
| Ex. 3c | 12 | 93.6 | 85.64 | 0.64 |
| Comp. Ex. 3a | 16 | 94.5 | 86.67 | 0.83 |
| Comp. Ex. 3b | 24 | 95.8 | 88.17 | 1.15 |

1. A radome wall comprising a multilayer sheet, the multilayer sheet comprising:
a) at least one sheet layer A comprising at least two monolayers, the monolayers comprising polymeric fibers, and
b) at least one first film layer B1 comprising a polyolefin,
wherein the multilayer sheet has a thickness of at least 0.05 mm and at most 0.8 mm.

2. The radome wall according to claim 1, wherein said multilayer sheet has a thickness in a range of at least 0.1 mm and at most 0.5 mm and preferably, a thickness in a range of at least 0.1 mm and at most 0.3 mm.

3. The radome wall according to claim 1, wherein the sheet layer A comprises at most 14 monolayers, preferably at most 8 monolayers and most preferably at most 4 monolayers.

4. The radome wall according to claim 1, wherein two monolayers are woven together in one woven fabric.

5. The radome wall according to claim 1, wherein the polymeric fibers comprise a polyolefin, preferably a polyethylene, most preferably ultrahigh molecular weight polyethylene.

6. The radome wall according to claim 1, wherein the polymeric fibers in layer A are polymeric tapes, preferably solid state polymeric tapes.

7. The radome wall according to claim 1, wherein the film layer B1 comprises a polyolefin, preferably a polyethylene, more preferably the film layer B1 is selected from a group comprising low density polyethylene, linear low density polyethylene, very low density polyethylene and/or mixtures thereof.

8. The radome wall according to claim 1, further comprising at least one second film layer B2 comprising a polymer selected from a group comprising a polyolefin and a functional polymer.

9. The radome wall according to claim 1, wherein the film layer B2 comprises a polymer selected from a group comprising polypropylenes, polyethylenes, polyurethanes, polyacrylates, epoxy resins, polyacetates, polycarbonates, polyesters, polyamides, acrylonitrile butadiene styrene; polystyrenes, polyamines, and/or mixtures thereof.

10. A radome comprising the radome wall according to claim 1.

11. The radome according to claim 10, the radome being a non-ballistic radome, preferably a non-ballistic radome suitable for telecommunications.

12. Use of the radome wall claim 1 in the construction of a radome.

13. A system comprising the radome according to claim 10 and an antenna and/or a radar.
